(19) United States
(12) Patent Application Publication
(10) Pub. No.: US 2020/0074026 A1
(43) Pub. Date: Mar. 5, 2020

(54) THERMAL ANALYSIS DEVICE AND THERMAL ANALYSIS METHOD

(71) Applicant: FUJITSU LIMITED, Kawasaki-shi (JP)

(72) Inventors: Jun Taniguchi, Isehara (JP); Takeshi Soeda, Kawasaki (JP)

(73) Assignee: FUJITSU LIMITED, Kawasaki-shi (JP)

(21) Appl. No.: 16/679,372

(22) Filed: Nov. 11, 2019

Related U.S. Application Data
(63) Continuation of application No. PCT/JP2017/021459, filed on Jun. 9, 2017.

(51) Int. Cl. G06F 17/50

(52) U.S. Cl. CPC G06F 17/5009; G06F 2217/80; G06F 2217/02

(57) ABSTRACT

A thermal analysis device includes a memory and a processor configured to perform estimation of whether a pair of components included in a target product has contact with each other by referring to first information obtained from design information of a product, the first information indicating whether two components have contact with each other, perform determination of a division number of the pair of components in a thermal network model by referring to second information indicating a relationship between a parameter regarding thermal transfer of components and a division number of the components in the thermal network model, perform generation of the thermal network model of the target product on the basis of a result of the estimation and another result of the determination, and perform thermal analysis based on the generated thermal network model of the target product.

### CROSS-REFERENCE TO RELATED APPLICATION

This application is a continuation application of International Application PCT/JP2017/021459 filed on Jun. 9, 2017 and designated the U.S., the entire contents of which are incorporated herein by reference.

### FIELD

The present invention relates to thermal analysis technology.

### BACKGROUND

Conventionally, in thermal analysis on a printed circuit board on which a heating component is mounted, a specialist or the like has created a model and performed thermal analysis according to an analysis purpose and analysis accuracy in each case. However, to create the model, rich knowledge and the like are required, and thermal analysis cannot be quickly performed. Therefore, in recent years, a technology for automatically constructing a model has been studied.

For example, the related art is disclosed in Japanese Laid-open Patent Publication No. 2004-318250, Japanese Laid-open Patent Publication No. 2007-122506, and Japanese Laid-open Patent Publication No. 2012-64036.

### SUMMARY

According to an aspect of the embodiments, a thermal analysis device includes a memory and a processor configured to perform estimation of whether a pair of components included in a target product has contact with each other by referring to first information obtained from design information of a product, the first information indicating whether two components have contact with each other, perform determination of a division number of the pair of components in a thermal network model by referring to second information indicating a relationship between a parameter regarding thermal transfer of components and a division number of the components in the thermal network model, perform generation of the thermal network model of the target product on the basis of a result of the estimation and another result of the determination, and perform thermal analysis based on the generated thermal network model of the target product.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram of a hardware configuration of a thermal analysis device according to one embodiment.

FIG. 2 is a functional block diagram of the thermal analysis device.

FIG. 3 is a diagram of data of each component pair.

FIGS. 4A to 4C are diagrams for explaining a division method.

FIG. 5 is a diagram of an exemplary data structure of a division method DB.

FIG. 6 is a diagram of exemplary component data.

FIG. 7A is a diagram of an estimation model table, and FIG. 7B is a diagram of a contact determination table.

FIG. 8 is a table indicating a network analysis result, an actual measurement value, and an error regarding a rising temperature of a display.

FIG. 9A is a diagram of exemplary data of a division method that is added to the division method DB by a learning unit, and FIG. 9B is a diagram of exemplary model data that is added to a design asset DB by the learning unit.

FIG. 10 is a flowchart of processing of the thermal analysis device.

FIG. 11 is a diagram for explaining a method for utilizing thermal analysis.

FIG. 12 is a diagram for explaining a modification.

FIG. 13 is a diagram of an example in which a cloud server has a function of the thermal analysis device.

### DESCRIPTION OF EMBODIMENTS

If thermal analysis can be performed in an upstream process in product design, a design guide can be easily made. To easily make the design guide, it is necessary to perform thermal analysis in a short time.

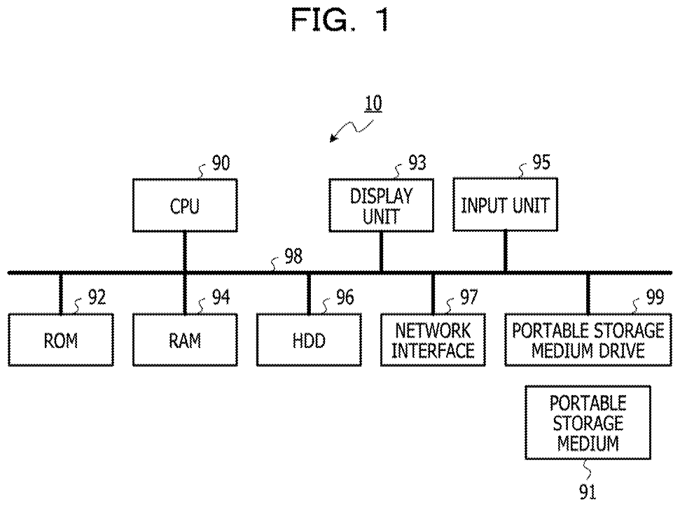

Hereinafter, one embodiment of a thermal analysis device will be described in detail with reference to FIGS. 1 to 11.

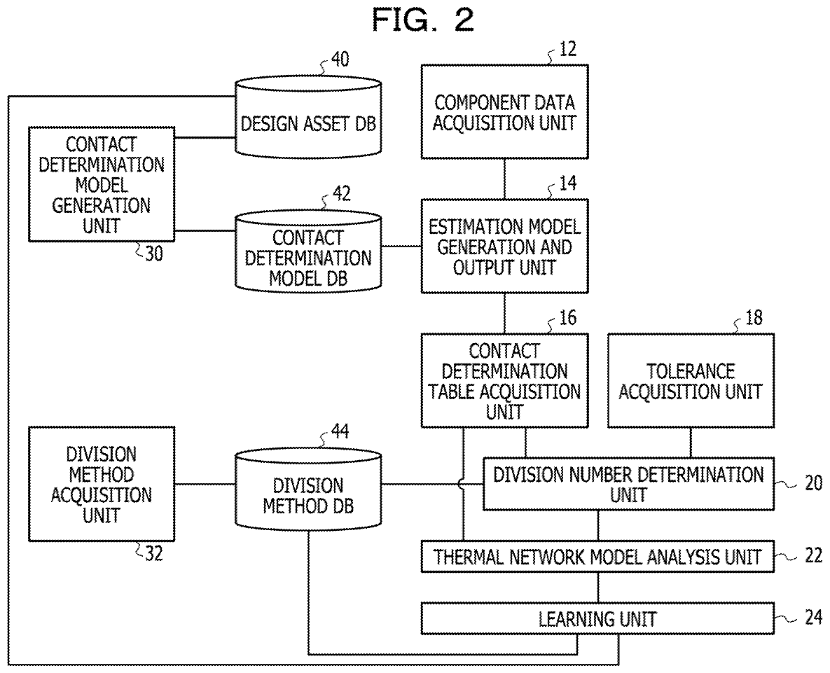

In FIG. 1, a hardware configuration of a thermal analysis device 10 is illustrated. The thermal analysis device 10 is a Personal Computer (PC) and the like, and as illustrated in FIG. 1, the thermal analysis device 10 includes a Central Processing Unit (CPU) 90, a Read Only Memory (ROM) 92, a Random Access Memory (RAM) 94, a storage unit (here, Hard Disk Drive (HDD)) 96, a network interface 97, a display unit 93, an input unit 95, a portable storage medium drive 99, and the like. Each component of the thermal analysis device 10 is connected to a bus 98. The display unit 93 includes a liquid crystal display and the like, and the input unit 95 includes a keyboard, a mouse, a touch panel, and the like. In the thermal analysis device 10, the CPU 90 executes a program (including thermal analysis program) stored in the ROM 92 or the HDD 96 or a program (including thermal analysis program) read from a portable storage medium 91 by the portable storage medium drive 99 so as to implement the function of each unit illustrated in FIG. 2. Note that in FIG. 2, databases (DB) stored in the HDD 96 of the thermal analysis device 10 and the like are illustrated.

In the thermal analysis device 10, the CPU 90 executes the program so as to implement functions of a contact determination model generation unit 30, a division method acquisition unit 32, a component data acquisition unit 12, an estimation model generation and output unit 14 as an estimation unit, a contact determination table acquisition unit 16, a tolerance acquisition unit 18 as a reception unit, a division number determination unit 20 as a determination unit, a thermal network model analysis unit 22 as a thermal analysis unit, and a learning unit 24 as an update unit illustrated in FIG. 2.

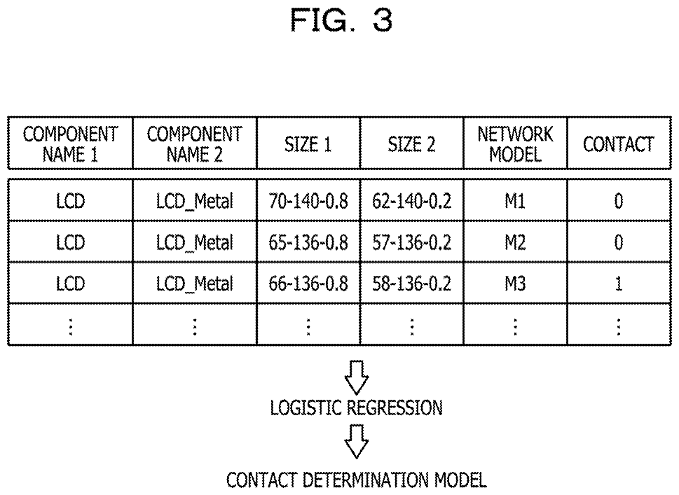

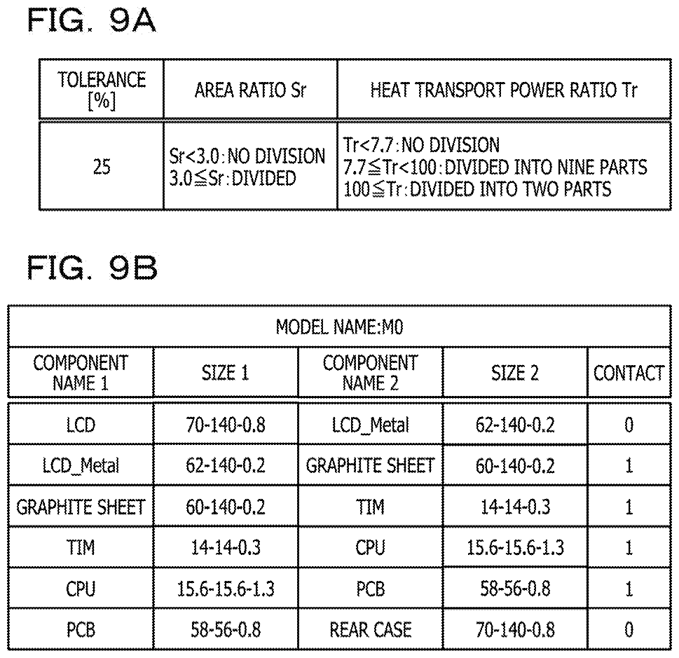

The contact determination model generation unit 30 acquires information regarding a past product stored in a design asset DB 40 and generates data of each component pair (FIG. 3) based on the acquired information. Here, the design asset DB 40 is a database that stores data similar to model data to be described later (refer to FIG. 9B). Furthermore, the data of each component pair includes data of two components having contact with each other or facing each other in a product. Specifically, the data of each component pair includes data of “component name 1” and “component name 2” that are names of the two components included in the component pair, data of “size 1” and “size 2” that are sizes of the respective components, data of “network model” that is a name of a network model used for thermal analysis, and data of “contact” indicating whether or not the component pair has contact with each other. In the data of “contact”, a value in a case where the component pair has contact with each other is “1”, and a value in a case where the component pair does not have contact with each other is “0”.

Furthermore, as illustrated in FIG. 3, the contact determination model generation unit 30 performs logistic regression on the data of each component pair and generates a contact determination model. The contact determination model is a model used to determine whether or not the two components (component pair) included in the product have contact with each other (for example, model used to calculate probability of contact). The contact determination model generation unit 30 stores the generated contact determination model in a contact determination model DB 42 as a first storage unit. Note that it can be said that the contact determination model is information regarding whether or not the two components have contact with each other obtained from product design information in the past.

The division method acquisition unit 32 acquires information regarding a division method based on a thermal network model which has been used in thermal analysis in the past, created by a user.

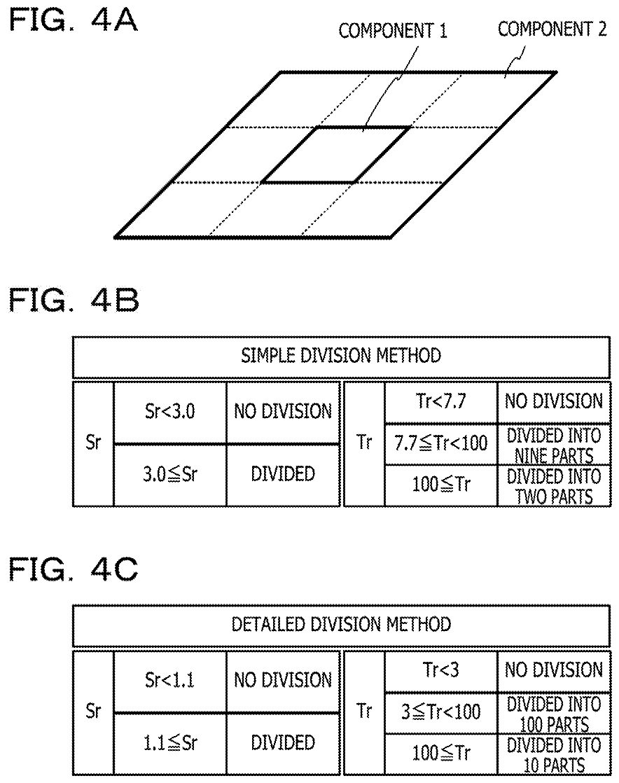

As an example, it is assumed that the division method according to the present embodiment be a method for determining the number of divisions by using an area ratio of the two components and a heat transport power ratio of the two components as parameters. FIGS. 4A to 4C are diagrams for explaining the division method. As illustrated in FIG. 4A, in a case where the component pair includes a component 1 and a component 2, an area ratio Sr and a heat transport power ratio Tr are respectively expressed as the following formulas (1) and (2).

Sr=area of component 2/area of component 1 (1)

Tr=heat transport power of component 2/heat transport power of component 1 (2)

Note that the heat transport power [W/K] is expressed as the following formula (3).

Heat transport power=heat conductivity x height of component (thickness) (3)

Then, the user divides the division methods into a simple division method (division method with large tolerance) and a detailed division method (division method with small tolerance) and determines a division method based on the thermal network model that has been used in the thermal analysis in the past.

For example, in the example in FIG. 4B, when a simple division method is used, in a case of Sr<3.0, no division is made, and in a case of 3.0≤Sr, division is made. Furthermore, if Tr<7.7, no division is made, in a case of 7.7≤Tr<100, division into nine parts is made, and in a case of 100≤Tr, division into two parts is made. On the other hand, when a detailed division method is used, as illustrated in FIG. 4C, in a case of Sr<1.1, no division is made, and in a case of 1.1≤Sr, division is made. Furthermore, if Tr<3, no division is made, in a case of 3≤Tr<100, division into 100 parts is made, and in a case of 100≤Tr, division into 10 parts is made.

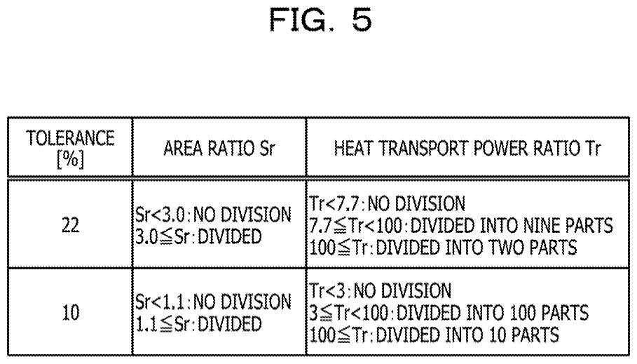

Then, the division method acquisition unit 32 performs thermal analysis on sample data (component data of sample product) by using the simple division method and the detailed division method and obtains an error between the analysis result and the actual measurement value. Then, the obtained error is associated with the division method, and a division method DB 44 as a second storage unit as illustrated in FIG. 5 is generated. Note that the division method DB 44 includes a plurality of records (rows), and it is assumed that a division method associated with an error closest to a tolerance input by the user be used by the division number determination unit 20 described later. Note that the user may determine how to use each division method in advance, for example, in a case where a tolerance is equal to or more than a predetermined value, the simple division method is used, and in a case where the tolerance is less than the predetermined value, the detailed division method is used.

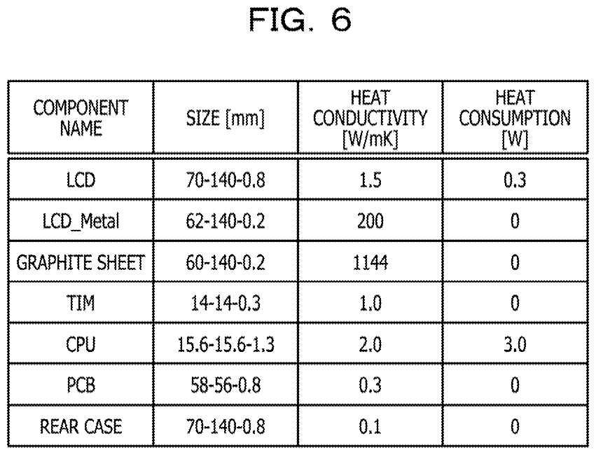

Returning to FIG. 2, the component data acquisition unit 12 acquires component data of a target product of the thermal analysis input by the user of the thermal analysis device 10. Here, as an example, it is assumed that the component data be data as illustrated in FIG. 6. Specifically, the component data is information regarding components included in the target product and includes each field of “component name”, “size”, “heat conductivity”, and “heat consumption”. In the field of “component name”, the name of the component is stored, and in the field of “size”, dimensions of the depth (D), the width (W), and the height (H) (unit [mm]) are stored. Furthermore, in the field of “heat conductivity”, a value of the heat conductivity (unit [W/mK]) is stored, and in the field of “heat consumption”, a value of the heat consumption (unit [W]) is stored.

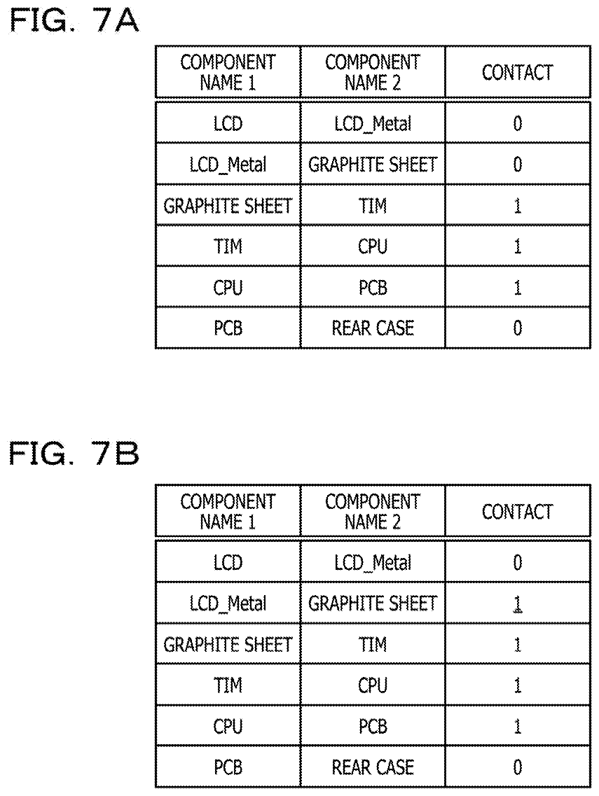

The estimation model generation and output unit 14 refers to the contact determination model DB 42 and estimates whether or not the components included in the component data acquired by the component data acquisition unit 12 have contact with each other. Furthermore, the estimation model generation and output unit 14 generates an estimation model table as illustrated in FIG. 7A as an estimation result and displays the generated table on the display unit 93. Here, the estimation model table includes fields of “component name 1” and “component name 2” that are names of the respective components included in the component pair and a field of “contact” indicating whether or not the component pair has contact with each other. Note that the user refers to the estimation model table, and if there was information to be corrected, the user corrects the information. Then, when the correction is completed, the user performs a confirmation operation (for example, to push confirmation button, and the like). In a case where the user performs the confirmation operation, the estimation model table becomes a contact determination table as illustrated in FIG. 7B. Note that as understood from the comparison with FIG. 7A, a contact state between a component name 1 “LCD_Metal” and a component name 2 “graphite sheet” in the contact determination table in FIG. 7B is corrected by the user.

Returning to FIG. 2, the contact determination table acquisition unit 16 acquires the estimation model table confirmed by the user (that is, contact determination table in FIG. 7B) and transmits the acquired contact determination table to the division number determination unit 20 and the thermal network model analysis unit 22.

The tolerance acquisition unit 18 prompts the user to input a tolerance (that is, required accuracy), acquires a value of the input tolerance, and transmits the value to the division number determination unit 20.

The division number determination unit 20 determines the division number of the thermal network model based on the division method DB 44 (FIG. 5) by using the tolerance acquired by the tolerance acquisition unit 18 and the data of the contact determination table acquired by the contact determination table acquisition unit 16. The division number determination unit 20 transmits information regarding the determined division number to the thermal network model analysis unit 22.

The thermal network model analysis unit 22 constructs a thermal network model by using the division number determined by the division number determination unit 20 and the information regarding the contact determination table and performs thermal analysis. Note that at the time of thermal analysis, the component data acquired by the component data acquisition unit 12 and the like are also used.

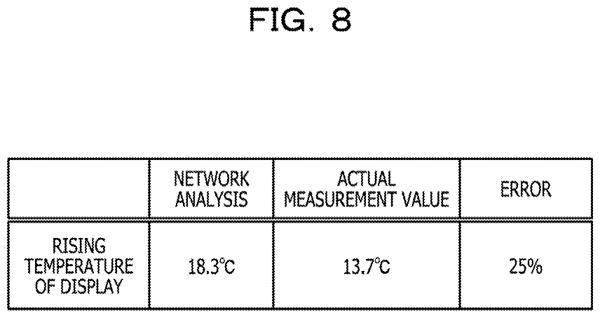

When acquiring an analysis result by the thermal network model analysis unit 22 and acquiring the actual measurement value and a simulation result (hereinafter, simply referred to as “actual measurement value”), the learning unit 24 calculates an error between the analysis result and the actual measurement value. In FIG. 8, a network analysis result, an actual measurement value, and an error regarding a rising temperature of a display are illustrated as an example. When it is assumed that the network analysis result of the rising temperature be ΔT1 and the actual measurement value of the rising temperature be ΔT2, an error P can be calculated by the following formula (4).

P(%)=(|ΔT1−ΔT2|/ΔT1)×100 (4)

Then, the learning unit 24 updates the division method DB 44 by using the calculated error and the division method and adds the information regarding the contact determination table used for the thermal analysis to the design asset DB 40. For example, the learning unit 24 adds the data in FIG. 9A to the division method DB 44 and adds the model data illustrated in FIG. 9B to the design asset DB 40. Note that the model data in FIG. 9B is a collection of component names and sizes of the component pairs included in the product on which the thermal analysis has been performed, and whether the component pair has contact with each other. Note that the contact determination model generation unit 30 may newly generate a contact determination model each time when new data is added to the design asset DB 40 and may generate only a contact determination model designated by the user. Note that in a case where the calculated error deviates from the tolerance input by the user, the learning unit 24 may appropriately correct the contact determination model DB 42 and the division method DB 44.

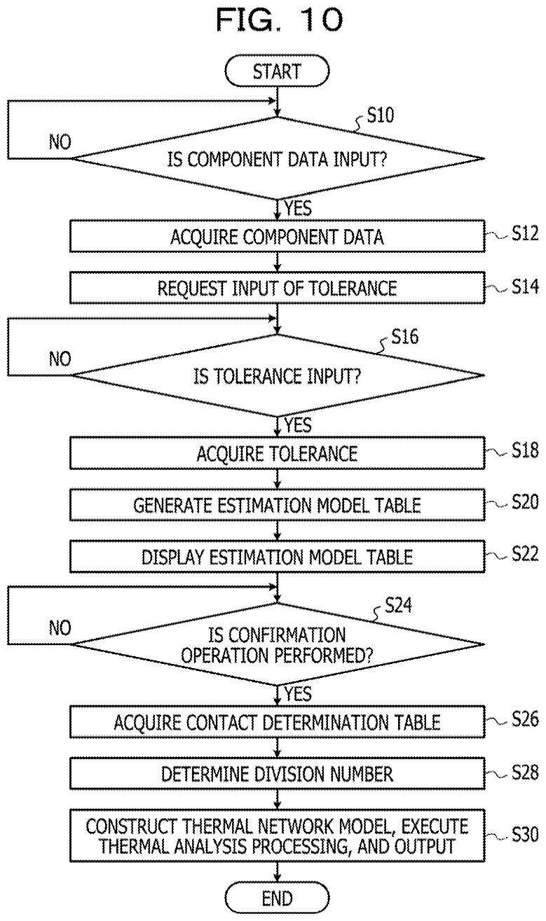

Next, processing by the thermal analysis device 10 will be described with reference to the flowchart in FIG. 10. Note that at the time when the processing in FIG. 10 is executed, the contact determination model DB 42 stores the contact determination model generated by the contact determination model generation unit 30, and the data in FIG. 5 is generated by the division method acquisition unit 32 and stored in the division method DB 44.

When the processing in FIG. 10 is started, the component data acquisition unit 12 waits for an input of the component data in step S10. When the component data is input, the component data acquisition unit 12 proceeds the procedure to step S12 and acquires the input component data (FIG. 6).

Next, in step S14, the tolerance acquisition unit 18 requests the user to input the tolerance via the display unit 93. Specifically, the tolerance acquisition unit 18 prompts the user to input the tolerance, for example, by displaying a tolerance input screen on the display unit 93.

Next, in step S16, the tolerance acquisition unit 18 waits for an input of the tolerance. When the user inputs the tolerance via the input unit 95, the tolerance acquisition unit 18 proceeds the procedure to step S18 and acquires the input tolerance.

Next, in step S20, the estimation model generation and output unit 14 generates the estimation model table (FIG. 7A) from the component data with reference to the contact determination model DB 42. Next, in step S22, the estimation model generation and output unit 14 displays the estimation model table generated in step S20 on the display unit 93.

Next, in step S24, the contact determination table acquisition unit 16 waits for the confirmation operation by the user. When the user performs the confirmation operation, the contact determination table acquisition unit 16 proceeds the procedure to step S26 and acquires the estimation model table that has been changed and confirmed (that is, contact determination table).

Next, in step S28, the division number determination unit 20 determines the division number for each component pair based on the tolerance with reference to the division method DB 44.

Next, in step S30, the thermal network model analysis unit 22 constructs the thermal network model based on the division number determined in step S28, the contact determination table, the component data, and the like, executes thermal analysis processing, and outputs a thermal analysis result (display on display unit 93).

As described above, at the time when the processing to step S30 is completed, all the processing in FIG. 10 is terminated. In the present embodiment, by executing the processing in FIG. 10, even if the user is not a trained expert, the thermal analysis can be performed in a short time. Note that it is assumed that the learning unit 24 appropriately execute the processing described above at a timing when the actual measurement value and the simulation result are acquired.

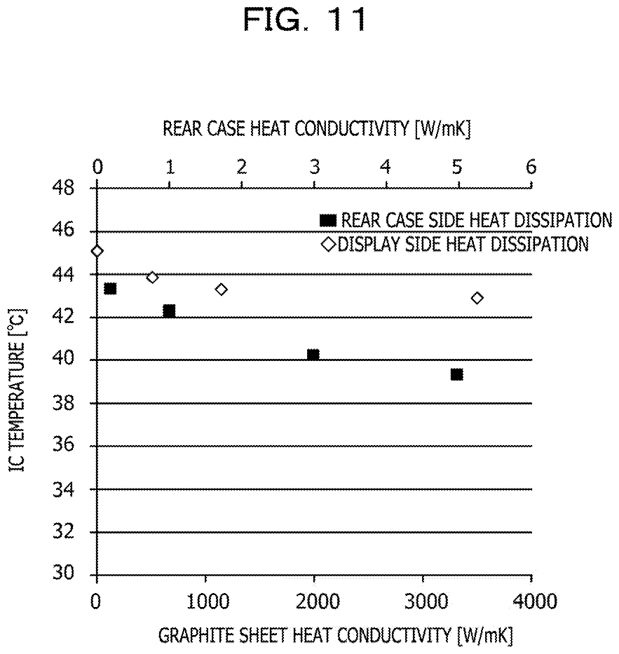

Here, for example, it is assumed to perform thermal analysis on a temperature of an Integrated Circuit (IC) in a case where a heat conductivity of a graphite sheet provided on a display side of the IC and a heat conductivity of a rear case are changed at the time of design of a mobile terminal. The thermal analysis result in this case is illustrated in FIG. 11. In the present embodiment, by executing the processing along the flowchart in FIG. 10 at the time of thermal analysis, the result as illustrated in FIG. 11 can be obtained in a short time. From this result, it is found that an effect in IC temperature reduction is more enhanced by increasing the heat conductivity of the rear case than by increasing the heat conductivity of the graphite sheet. Therefore, a designer can design based on this result. Note that a workload to obtain the result in FIG. 11 can be reduced to about 1/3 than a case where a heat dissipation path to be reflected in thermal design is found as referring to Computer Aided Design (CAD) data to construct a model or a person sets the number of nodes per component as referring to experimental data and design asset (comparative example).

As described above in detail, according to the present embodiment, the estimation model generation and output unit 14 refers to the contact determination model DB 42 that stores the contact determination model obtained from the design asset in the past, estimates whether or not the component pair included in the target product has contact with each other, and generates the estimation model table (S20). Furthermore, the division number determination unit 20 refers to the division method DB 44 that stores a relationship between the parameters (Sr and Tr) regarding the thermal transfer of the two components and the division number of the thermal network model and determines the division number of the thermal network model of the component pair included in the target product (S28). Then, the thermal network model analysis unit 22 constructs the thermal network model of the target product by using the contact determination table obtained by correcting the estimation model table and the division number determined by the division number determination unit 20 and performs thermal analysis (S30). With this operation, in the present embodiment, even if the user is not a skilled designer and the like, the contact determination table can be easily created, and the division number can be automatically determined. Therefore, the construction of the thermal network model and the thermal analysis can be performed in a short time. Accordingly, since a large number of product configurations can be examined in an upstream process in the product design, the design can be easily made. Furthermore, even when thermal analysis is performed on a system in which components and sizes are mixed, the thermal analysis can be efficiently performed by using the contact determination model.

Furthermore, in the present embodiment, the thermal network model is constructed by using the table (contact determination table) confirmed after the estimation model table generated by the estimation model generation and output unit 14 is output and confirmed and corrected by the user. With this operation, it is possible to perform thermal analysis after reflecting a design guide of the user.

Furthermore, in the present embodiment, the tolerance acquisition unit 18 receives the input of the tolerance in the thermal analysis and determines the division number by the division method corresponding to the tolerance. Therefore, the appropriate division number can be determined with accuracy required by the user.

Furthermore, in the present embodiment, the design asset DB 40 and the division method DB 44 are updated (learned) based on the thermal analysis result. Therefore, determination accuracy regarding whether or not the components have contact with each other and determination accuracy of the division number can be increased.

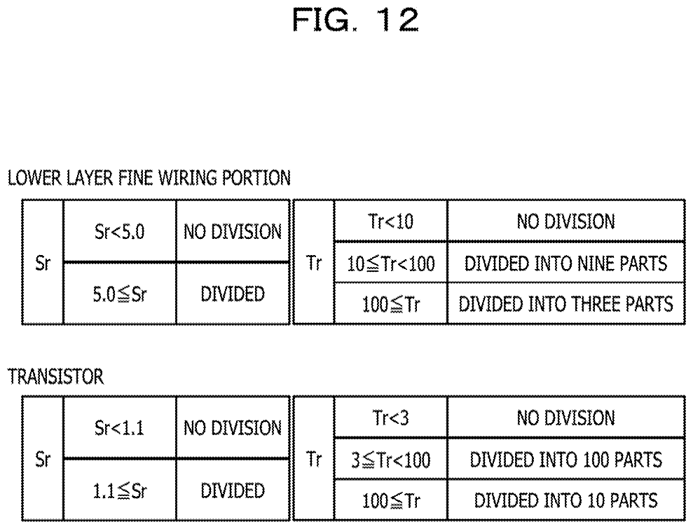

Note that in the embodiment, the thermal analysis processing of the product such as the mobile terminal has been described. However, the present invention is not limited to this. For example, when a model used to estimate a temperature of a part that is difficult to predict from an analysis result of a broken LSI is constructed, the method similar to that in the embodiment can be adopted. In this case, for example, as in a case of multilayer, in a case where a size and a material of an analysis target largely differ according to a layer, as illustrated in FIG. 12, the division number of a certain layer (for example, lower layer fine wiring portion) and the division number of another layer (for example, transistor) may be determined by different division methods.

Note that in the embodiment, as the parameters regarding the thermal transfer of the two components that are used when the division number is determined, the area ratio and the heat transport power ratio are used. However, the present invention is not limited to this, and only one of the area ratio and the heat transport power ratio may be used. Furthermore, as the parameters regarding the thermal transfer of the two components, a parameter other than the area ratio and the heat transport power ratio may be adopted.

Note that in the embodiment, a case has been described in which the user is made to input the tolerance and the division number determination unit 20 determines the division number based on the tolerance. However, the present invention is not limited to this. For example, the division number determination unit 20 may determine the division number without using the tolerance. In this case, it is sufficient that only one type of division method be prepared.

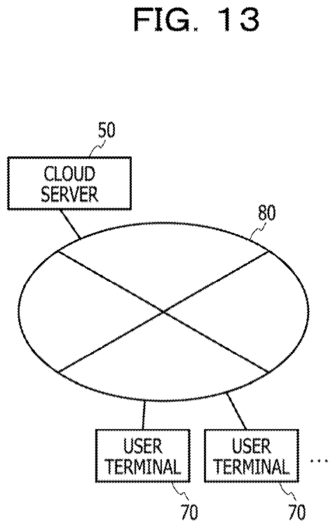

Note that in the embodiment, a case has been described in which the thermal analysis device 10 has each function in FIG. 2. However, the present invention is not limited to this. For example, a cloud server 50 connected to a network 80 such as the Internet as illustrated in FIG. 13 may has each function in FIG. 2. In this case, the cloud server 50 receives component data, a tolerance, and the like input from a user terminal 70 and executes the processing in FIG. 10. Note that the cloud server 50 may be provided anywhere in Japan and overseas.

Note that the processing functions described above can be implemented by a computer. In that case, a program is provided in which processing content of a function to be included in a processing apparatus is written. The above processing functions are implemented on the computer by executing the program by the computer. The program in which the processing content is written can be recorded in a computer-readable reading medium (except for a carrier wave).

In a case of distributing the program, for example, the program is sold in the form of a portable reading medium such as a digital versatile disc (DVD) or a compact disc read only memory (CD-ROM) in which the program is recorded. Alternatively, it is possible to store the program in a storage device of a server computer and transfer the program from the server computer to another computer via a network.

The computer which executes the program stores, for example, the program recorded in the portable reading medium or the program transferred from the server computer in a storage device of the computer. Then, the computer reads the program from the storage device of the computer and executes processing according to the program. Note that the computer can directly read the program from the portable reading medium and execute processing according to the program. Furthermore, the computer also can sequentially execute processing according to the received program each time when the program is transferred from the server computer.

The embodiment described above is a preferred example of carrying out the present invention. However, the present invention is not limited to this, and a variety of modifications can be made without departing from the scope of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A thermal analysis device comprising:
a memory; and
a processor coupled to the memory and the processor configured to:
perform estimation of whether a pair of components included in a target product has contact with each other by referring to first information obtained from design information of a product, the first information indicating whether two components have contact with each other,
perform determination of a division number of the pair of components in a thermal network model by referring to second information indicating a relationship between a parameter regarding thermal transfer of components and a division number of the components in the thermal network model,
perform generation of the thermal network model of the target product on the basis of a result of the estimation and another result of the determination, and
perform thermal analysis based on the generated thermal network model of the target product.

2. The thermal analysis device according to claim 1, wherein
the generation includes:
receiving a correction request of the result of the estimation,
modifying the result of the estimation based on the correction request, and
generating the thermal network model of the target product based on the modified result of the estimation.

3. The thermal analysis device according to claim 1, wherein
the second information indicates the relationship for each accuracy for the thermal analysis, and
the determination includes:
receiving information indicating first accuracy for the thermal analysis, and
determining the division number of the pair of components in the thermal network model based on the relationship for the first accuracy indicated by the information.

4. The thermal analysis device according to claim 1, wherein
the parameter regarding the thermal transfer includes an area ratio of the components.

5. The thermal analysis device according to claim 1, wherein
the parameter regarding the thermal transfer includes a ratio of ease of thermal transfer in the components.

6. The thermal analysis device according to claim 1, wherein
the processor is further configured to update, based on a thermal analysis result of the thermal analysis, the first information by using the result of the estimation and the second information by using the other result of the determination.

7. A computer-implemented thermal analysis method comprising:
estimating whether a pair of components included in a target product has contact with each other by referring to first information obtained from design information of a product, the first information indicating whether two components have contact with each other;
determining a division number of the pair of components in a thermal network model by referring to second information indicating a relationship between a parameter regarding thermal transfer of components and a division number of the components in the thermal network model;
generating the thermal network model of the target product on the basis of a result of the estimating and another result of the determining; and
performing thermal analysis based on the generated thermal network model of the target product.

8. The thermal analysis method according to claim 7, wherein
the generating includes:
receiving a correction request of the result of the estimation,
modifying the result of the estimating based on the correction request, and
generating the thermal network model of the target product based on the modified result of the estimating.

9. The thermal analysis method according to claim 7, wherein
the second information indicates the relationship for each accuracy for
the thermal analysis, and the determining includes:
receiving information indicating first accuracy for the thermal analysis, and
determining the division number of the pair of components in the thermal network model based on the relationship for the first accuracy indicated by the information.

10. The thermal analysis method according to claim 7, wherein
the parameter regarding the thermal transfer includes an area ratio of the components.

11. The thermal analysis method according to claim 7, wherein
the parameter regarding the thermal transfer includes a ratio of ease of thermal transfer in the components.

12. The thermal analysis method according to claim 7, further comprising:
updating, based on a thermal analysis result of the thermal analysis, the first information by using the result of the estimation and the second information by using the other result of the determination.

13. A non-transitory computer-readable medium storing thermal analysis program executable by one or more computers, the thermal analysis program comprising:
one or more instructions for estimating whether a pair of components included in a target product has contact with each other by referring to first information obtained from design information of a product, the first information indicating whether two components have contact with each other;
one or more instructions for determining a division number of the pair of components in a thermal network model by referring to second information indicating a relationship between a parameter regarding thermal transfer of components and a division number of the components in the thermal network model;
one or more instructions for generating the thermal network model of the target product on the basis of a result of the estimating and another result of the determining; and
one or more instructions for performing thermal analysis based on the generated thermal network model of the target product.
